(19) United States
(12) Patent Application Publication
(10) Pub. No.: US 2024/0039588 A1
(43) Pub. Date: Feb. 1, 2024

(54) METHOD AND APPARATUS FOR TRANSMITTING AND RECEIVING CHANNEL STATE INFORMATION IN COMMUNICATION SYSTEM

(71) Applicant: ELECTRONICS AND TELECOMMUNICATIONS RESEARCH INSTITUTE, Daejeon (KR)

(72) Inventors: An Seok LEE, Daejeon (KR); Han Jun PARK, Daejeon (KR); Yong Jin KWON, Daejeon (KR); Heesoo LEE, Daejeon (KR); Yun Joo KIM, Daejeon (KR); Hyun Seo PARK, Daejeon (KR); Jung Bo SON, Daejeon (KR); Yu Ro LEE, Daejeon (KR)

(73) Assignee: ELECTRONICS AND TELECOMMUNICATIONS RESEARCH INSTITUTE, Daejeon (KR)

(21) Appl. No.: 18/361,279

(22) Filed: Jul. 28, 2023

(30) Foreign Application Priority Data
Jul. 29, 2022 (KR) 10-2022-0094900
Feb. 17, 2023 (KR) 10-2023-0021302
Jun. 26, 2023 (KR) 10-2023-0081912

(51) Int. Cl. H04B 7/0456; H04B 7/06

(52) U.S. Cl. CPC H04B 7/0478; H04B 7/0634; H04B 7/0626

(57) ABSTRACT

A method of a terminal may comprise: receiving a reference signal from a base station; generating a precoding vector based on the reference signal; generating a low-dimensional precoding vector by performing dimensionality reduction transformation on the precoding vector; quantizing the low-dimensional precoding vector; and transmitting the quantized low-dimensional precoding vector to the base station.

### CROSS-REFERENCE TO RELATED APPLICATIONS

This application claims priority to Korean Patent Applications No. 10-2022-0094900, filed on Jul. 29, 2022, No. 10-2023-0021302, filed on Feb. 17, 2023, and No. 10-2023-0081912, filed on Jun. 26, 2023, with the Korean Intellectual Property Office (KIPO), the entire contents of which are hereby incorporated by reference.

### BACKGROUND

### 1. Technical Field

Exemplary embodiments of the present disclosure relate to a technique for transmitting and receiving channel state information, and more specifically, to a technique for transmitting and receiving channel state information in a communication system, which transforms a precoding vector to a low-dimensional precoding vector, quantizes the transformed precoding vector, and provides information on the quantized precoding vector to a base station.

### 2. Related Art

With the development of information and communication technology, various wireless communication technologies have been developed. Typical wireless communication technologies include long term evolution (LTE), new radio (NR), 6th generation (6G) communication, and/or the like. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g., Long Term Evolution (LTE) communication system or LTE-Advanced (LTE-A) communication system), the 5th generation (5G) communication system (e.g., new radio (NR) communication system) that uses a frequency band (e.g., a frequency band of 6 GHz or above) higher than that of the 4G communication system as well as a frequency band of the 4G communication system (e.g., a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, in a mobile communication system, a transmitter may transmit data to a receiver. In this case, the transmitter may acquire and use channel information measured by the receiver through a channel state information (CSI) reporting procedure. To support this, the mobile communication system may use an auto-encoder-based neural network as a machine learning structure for delivering the channel information. In a case where mutual compatibility is not satisfied in such the autoencoder, the receiver's encoder and the transmitter's decoder should be developed and trained by one entity to perform expected operations. Therefore, the encoder and decoder of the autoencoder, which are developed and trained by different entities, cannot be connected and operated.

### SUMMARY

Exemplary embodiments of the present disclosure are directed to providing a method and an apparatus for transmitting and receiving channel state information in a communication system, which transforms a precoding vector to a low-dimensional precoding vector, quantizes the transformed precoding vector, and provides information on the quantized precoding vector to a base station.

According to a first exemplary embodiment of the present disclosure, a method of a terminal may comprise: receiving a reference signal from a base station; generating a precoding vector based on the reference signal; generating a low-dimensional precoding vector by performing dimensionality reduction transformation on the precoding vector; quantizing the low-dimensional precoding vector; and transmitting the quantized low-dimensional precoding vector to the base station.

The method may further comprise: receiving information on principal component vectors from the base station, wherein in the generating of the low-dimensional precoding vector, the low-dimensional precoding vector may be generated by performing dimensionality reduction transformation on the precoding vector through a principal component analysis scheme using the principal component vectors.

Information on the principal component vectors may be received from the base station in a form of higher layer configuration parameter(s).

In the generating of the low-dimensional precoding vector, the low-dimensional precoding vector may be generated by performing dimensionality reduction transformation on the precoding vector through an independent component analysis scheme.

The quantizing of the low-dimensional precoding vector may comprise: transforming elements of the low-dimensional precoding vector by applying a distribution function; and quantizing the elements transformed through the distribution function.

The distribution function may be one of a cumulative distribution function (CDF) function, a CDF function approximated as a normal distribution function, or a normal distribution function.

In the quantizing of the elements transformed through the distribution function, the quantizing may be performed using at least one of a uniform quantization scheme, a scalar quantization scheme, or a quantization scheme using a Lloyd Max quantizer.

In the quantizing of the low-dimensional precoding vector, elements of all dimensions of the low-dimensional precoding vector or elements of each dimension of the low-dimensional precoding vector may be quantized.

When the elements of each dimension of the low-dimensional precoding vector are quantized, a bit length may be maintained to be identical between dimensions or decreases as the dimension increases.

When the elements of each dimension of the low-dimensional precoding vector are quantized, a bit length for each dimension may be determined according to importance based on an explained variance of each dimension.

According to a second exemplary embodiment of the present disclosure, a method of a terminal may comprise: receiving, from a base station, information on reporting subbands among subbands of a use band; receiving a reference signal from the base station; generating precoding vectors for the reporting target subbands based on the reference signal; generating low-dimensional precoding vectors by performing dimensionality reduction transformation on the precoding vectors; quantizing the low-dimensional precoding vectors; and transmitting the quantized low-dimensional precoding vectors to the base station.

The information on the reporting target subbands may be one of: information indicating all of the subbands of the use band as the reporting target subbands, information indicating subbands expected to be used among the subbands of the use band as the reporting target subbands, information indicating an index of a starting subband among the subbands of the use band and an interval between subbands, or information indicating a number of the reporting target subbands and an interval between subbands.

The generating of the low-dimensional precoding vectors may comprise: decomposing the precoding vectors for the reporting target subbands into a wideband precoding vector and a residual precoding vector for each subband; generating a wideband low-dimensional precoding vector from among the low-dimensional precoding vectors by performing dimensionality reduction transformation on the wideband precoding vector using first principal component vectors; and generating a low-dimensional precoding vector for each subband from among the low-dimensional precoding vectors by performing dimensionality reduction transformation on the residual precoding vector for each subband using second principal component vectors.

The generating of the low-dimensional precoding vectors may comprise: generating antenna-domain low-dimensional precoding vectors from among the low-dimensional precoding vectors by performing dimensionality reduction transformation on the precoding vectors for the reporting target subbands using antenna-domain principal component vectors; and generating subband-domain low-dimensional precoding vectors from among the antenna-domain low-dimensional precoding vectors by performing dimensionality reduction transformation on the antenna-domain low-dimensional precoding vectors using subband-domain principal component vectors.

According to a third exemplary embodiment of the present disclosure, a method of a base station may comprise: transmitting a reference signal to a terminal; receiving a quantized low-dimensional precoding vector based on the reference signal from the terminal; generating a low-dimensional precoding vector by dequantizing the quantized low-dimensional precoding vector; and reconstructing a precoding vector from the low-dimensional precoding vector.

In the reconstructing of the original precoding vector, the precoding vector may be reconstructed from the low-dimensional precoding vector in an inverse principal component analysis scheme.

The method may further comprise: restoring an original precoding vector from the reconstructed precoding vector by using an artificial neural network.

The artificial neural network may be one of a fully-connected neural network, a multi-layer perceptron, a convolutional neural network, or a transformer.

The quantized low-dimensional precoding vector may be received together with information on a number of reduced dimensions and information on a bit length for each dimension, and the low-dimensional precoding vector may be generated through dequantization on the quantized low-dimensional precoding vector using the information on the number of reduced dimensions and the information on the bit length.

According to the present disclosure, the terminal may perform dimensionality reduction on a precoding vector using principal component analysis (PCA), quantize the precoding vector, and deliver the quantized precoding vector to the base station. Then, the base station may identify a channel state by receiving the quantized precoding vector subjected to dimensionality reduction. As a result, according to the present disclosure, the base station and terminal can solve a difficulty in operations of a combination of transceivers developed by various entities due to a lack of compatibility in auto-encoder-based compression and restoration techniques of channel state information.

### BRIEF DESCRIPTION OF DRAWINGS

FIG. 1 is a conceptual diagram illustrating a first exemplary embodiment of a communication system.

FIG. 2 is a block diagram illustrating a first exemplary embodiment of a communication node constituting a communication system.

FIG. 3 is a flowchart illustrating a first exemplary embodiment of a method for transmitting CSI in a communication system.

FIG. 4 is a conceptual diagram illustrating a first exemplary embodiment of a process of generating a low-dimensional precoding vector of FIG. 3.

FIG. 5 is a conceptual diagram illustrating a first exemplary embodiment of a process of quantizing elements of the low-dimensional precoding vector of FIG. 3.

FIG. 6 is a conceptual diagram illustrating a second exemplary embodiment of a process of quantizing elements of the low-dimensional precoding vector.

FIG. 7 is a graph illustrating a first exemplary embodiment of a method of setting a bit length for each dimension.

FIG. 8 is a flowchart illustrating a second exemplary embodiment of a method for transmitting CSI in a communication system.

FIG. 9 is a conceptual diagram illustrating a first exemplary embodiment of a process of generating a wideband precoding vector and a residual precoding vector.

FIG. 10 is a conceptual diagram illustrating a first exemplary embodiment of a method for selecting some subbands from target subbands.

FIG. 11 is a flowchart illustrating a third exemplary embodiment of a method for transmitting CSI in a communication system.

FIG. 12 is a flowchart illustrating a first exemplary embodiment of a method for receiving CSI in a communication system.

FIG. 13 is a diagram illustrating a first exemplary embodiment of a method of restoring a precoding vector based on an artificial neural network.

FIG. 14 is a diagram illustrating a second exemplary embodiment of a method of restoring a precoding vector based on an artificial neural network.

FIG. 15 is a diagram illustrating a third exemplary embodiment of a method of restoring a precoding vector based on an artificial neural network.

FIG. 16 is a flowchart illustrating a third exemplary embodiment of a method for transmitting CSI in a communication system.

FIG. 17 is a flowchart illustrating a second exemplary embodiment of a method for receiving CSI in a communication system.

### DETAILED DESCRIPTION OF THE EMBODIMENTS

Since the present disclosure may be variously modified and have several forms, specific exemplary embodiments will be shown in the accompanying drawings and be described in detail in the detailed description. It should be understood, however, that it is not intended to limit the present disclosure to the specific exemplary embodiments but, on the contrary, the present disclosure is to cover all modifications and alternatives falling within the spirit and scope of the present disclosure.

Relational terms such as first, second, and the like may be used for describing various elements, but the elements should not be limited by the terms. These terms are only used to distinguish one element from another. For example, a first component may be named a second component without departing from the scope of the present disclosure, and the second component may also be similarly named the first component. The term “and/or” means any one or a combination of a plurality of related and described items.

In exemplary embodiments of the present disclosure, “at least one of A and B” may refer to “at least one of A or B” or “at least one of combinations of one or more of A and B”. In addition, “one or more of A and B” may refer to “one or more of A or B” or “one or more of combinations of one or more of A and B”.

When it is mentioned that a certain component is “coupled with” or “connected with” another component, it should be understood that the certain component is directly “coupled with” or “connected with” to the other component or a further component may be disposed therebetween. In contrast, when it is mentioned that a certain component is “directly coupled with” or “directly connected with” another component, it will be understood that a further component is not disposed therebetween.

The terms used in the present disclosure are only used to describe specific exemplary embodiments, and are not intended to limit the present disclosure. The singular expression includes the plural expression unless the context clearly dictates otherwise. In the present disclosure, terms such as ‘comprise’ or ‘have’ are intended to designate that a feature, number, step, operation, component, part, or combination thereof described in the specification exists, but it should be understood that the terms do not preclude existence or addition of one or more features, numbers, steps, operations, components, parts, or combinations thereof.

Unless otherwise defined, all terms (including technical and scientific terms) used herein have the same meaning as commonly understood by one of ordinary skill in the art to which this disclosure belongs. Terms that are generally used and have been in dictionaries should be construed as having meanings matched with contextual meanings in the art. In this description, unless defined clearly, terms are not necessarily construed as having formal meanings.

Hereinafter, forms of the present disclosure will be described in detail with reference to the accompanying drawings. In describing the disclosure, to facilitate the entire understanding of the disclosure, like numbers refer to like elements throughout the description of the figures and the repetitive description thereof will be omitted.

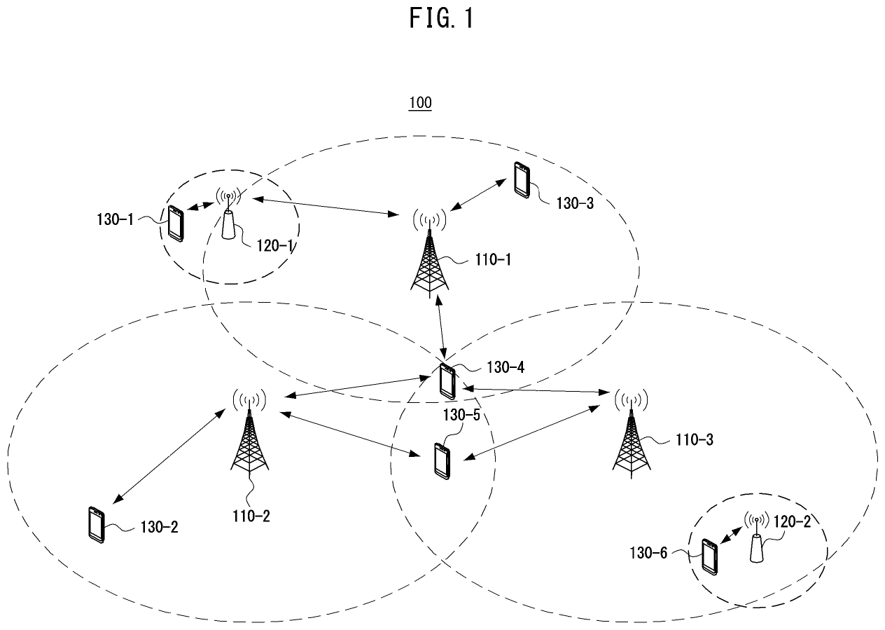

FIG. 1 is a conceptual diagram illustrating a first exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. Here, the communication system may be referred to as a ‘communication network’. Each of the plurality of communication nodes may support code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform-spread-OFDM (DFT-s-OFDM) based communication protocol, orthogonal frequency division multiple access (OFDMA) based communication protocol, single-carrier FDMA (SC-FDMA) based communication protocol, non-orthogonal multiple access (NOMA) based communication protocol, generalized frequency division multiplexing (GFDM) based communication protocol, filter band multi-carrier (FBMC) based communication protocol, universal filtered multi-carrier (UFMC) based communication protocol, space division multiple access (SDMA) based communication protocol, or the like. Each of the plurality of communication nodes may have the following structure.

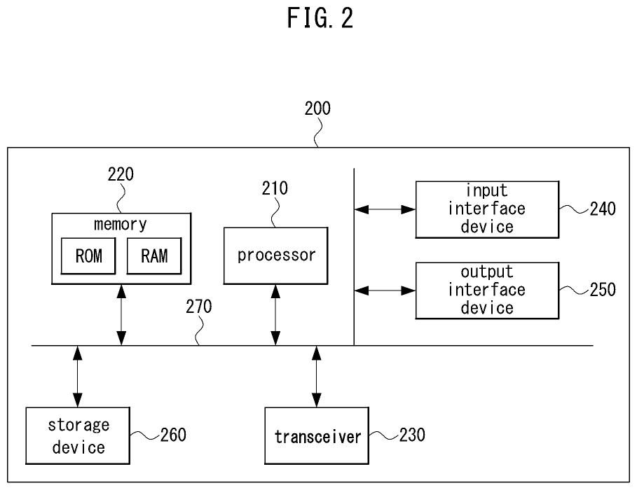

FIG. 2 is a block diagram illustrating a first exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. The respective components included in the communication node 200 may communicate with each other as connected through a bus 270. However, the respective components included in the communication node 200 may be connected not to the common bus 270 but to the processor 210 through an individual interface or an individual bus. For example, the processor 210 may be connected to at least one of the memory 220, the transceiver 230, the input interface device 240, the output interface device 250, and the storage device 260 through dedicated interfaces.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to the cell coverage of the first base station 110-1. Also, the second terminal 130-2, the fourth terminal 130-4, and the fifth terminal 130-5 may belong to the cell coverage of the second base station 110-2. Also, the fifth base station 120-2, the fourth terminal 130-4, the fifth terminal 130-5, and the sixth terminal 130-6 may belong to the cell coverage of the third base station 110-3. Also, the first terminal 130-1 may belong to the cell coverage of the fourth base station 120-1, and the sixth terminal 130-6 may belong to the cell coverage of the fifth base station 120-2.

Here, each of the plurality of base stations 110-1, 110-2, 110-3, 120-1, and 120-2 may be referred to as NodeB (NB), evolved NodeB (eNB), gNB, advanced base station (ABS), high reliability-base station (HR-BS), base transceiver station (BTS), radio base station, radio transceiver, access point (AP), access node, radio access station (RAS), mobile multihop relay-base station (MMR-BS), relay station (RS), advanced relay station (ARS), high reliability-relay station (HR-RS), home NodeB (HNB), home eNodeB (HeNB), road side unit (RSU), radio remote head (RRH), transmission point (TP), transmission and reception point (TRP), relay node, or the like. Each of the plurality of terminals 130-1, 130-2, 130-3, 130-4, 130-5, and 130-6 may be referred to as user equipment (UE), terminal equipment (TE), advanced mobile station (AMS), high reliability-mobile station (HR-MS), terminal, access terminal, mobile terminal, station, subscriber station, mobile station, portable subscriber station, node, device, on-board unit (OBU), or the like.

Each of the plurality of communication nodes 110-1, 110-2, 110-3, 120-1, 120-2, 130-1, 130-2, 130-3, 130-4, 130-5, and 130-6 may support cellular communication (e.g., LTE, LTE-Advanced (LTE-A), New radio (NR), etc.). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul link or a non-ideal backhaul link, and exchange information with each other via the ideal or non-ideal backhaul. Also, each of the plurality of base stations 110-1, 110-2, 110-3, 120-1, and 120-2 may be connected to the core network through the ideal backhaul link or non-ideal backhaul link. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

Each of the plurality of base stations 110-1, 110-2, 110-3, 120-1, and 120-2 may support OFDMA-based downlink (DL) transmission, and SC-FDMA-based uplink (UL) transmission. In addition, each of the plurality of base stations 110-1, 110-2, 110-3, 120-1, and 120-2 may support a multi-input multi-output (MIMO) transmission (e.g., single-user MIMO (SU-MIMO), multi-user MIMO (MU-MIMO), massive MIMO, or the like), a coordinated multipoint (CoMP) transmission, a carrier aggregation (CA) transmission, a transmission in unlicensed band, a device-to-device (D2D) communication (or, proximity services (ProSe)), an Internet of Things (IoT) communication, a dual connectivity (DC), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2 (i.e., the operations supported by the plurality of base stations 110-1, 110-2, 110-3, 120-1, and 120-2).

Meanwhile, in a mobile communication system, a transmitter may transmit data to a receiver by performing encoding of a data signal, power allocation, and beamforming using multiple transmit antennas. In this case, the transmitter may need information on a radio channel between antennas of the transmitter and the receiver. However, the transmitter cannot directly observe the radio channel from the transmitter to the receiver. Accordingly, the transmitter may receive channel information measured by the receiver from the receiver through a channel state information (CSI) reporting procedure, and use the channel information. Here, CSI may be used for scheduling data transmission from the transmitter to the receiver, and may include rank information, channel quality index (CQI), and precoding information.

A reference signal such as a CSI-reference signal (CSI-RS) may be designed to measure a channel state in the receiver. Accordingly, the transmitter may periodically or aperiodically transmit the CSI-RS to the receiver. In this case, the transmitter may configure transmission-related information in the receiver in advance so that the receiver can receive the CSI-RS. Accordingly, the receiver may receive the CSI-RS from the base station, and perform a CSI reporting procedure of generating CSI and delivering the CSI to the transmitter.

In this case, the CSI may be very large in order to accurately represent the channel information. As a result, the CSI may increase an occupancy and overhead of radio transmission resources, thereby reducing the performance of the communication system. In particular, if the CSI accurately represents channel information for expressing variation in the radio channel in order to allow the transmitter to determine a precoding, a large overhead may be caused. In addition, if the CSI accurately represents precoding information in order to allow the transmitter to recommend an appropriate precoding vector to the receiver, a large overhead may be caused.

In order to solve the above-described problem, the mobile communication system may allow the transmitter to acquire CSI with high accuracy while minimizing the amount of transmission information by using machine learning (ML) techniques. To this end, the mobile communication system may use an auto-encoder-based neural network as an ML structure for delivering channel information. The auto-encoder may input radio channel information in a form of an image, and compress it into a code vector of a low-dimensional latent space through an encoder network. Then, the autoencoder may restore the compressed code vector of the low-dimensional latent space to original radio channel information through a decoder network. Such the auto-encoder may be an artificial neural network based on a convolutional neural network (CNN).

Such the auto-encoder may transmit the entire channel information. As a result, the amount of information to be transmitted may be large. In addition, the compressed low-dimensional code vector may have real values. Accordingly, the communication system may additionally require a quantization process or the like to transfer the compressed low-dimensional code vector from the receiver to the transmitter. In order to solve the above problem, the receiver may extract an eigen vector of the radio channel from the entire channel information, and compress and transmit the eigen vector. In this case, a compression and reconstruction process considering the quantization may be used.

However, the above-described scheme may additionally require mutual compatibility in order to be applied to an actual network. Here, mutual compatibility may mean that the decoder of the transmitter and the encoder of the receiver should be able to operate in combination even if they are developed by different entities. In a case where such mutual compatibility is not satisfied, the encoder of the receiver and the decoder of the transmitter should be developed and trained by one entity to perform expected operations. Due to its nature, the auto-encoder may not know a rule used for mapping original information into a low-dimensional latent space. In addition, the auto-encoder may be optimized in a form that minimizes a loss function in a training process. In this reason, it is impossible to connect and operate the encoder and decoder of the auto-encoder, which are developed and trained by different entities.

Accordingly, the present disclosure provides CSI transmission/reception techniques using an auto-encoder-based artificial neural network. The present disclosure proposes methods to solve a problem of difficulty in mutual compatibility between an encoder and a decoder which are developed or trained by different entities. Methods proposed in the present disclosure allow CSI feedback information generated by different entities to be restored into a precoding vector through an artificial neural network.

More specifically, the base station and the terminal may share information on principal component vectors in advance. The terminal may perform dimensionality reduction transformation on a precoding vector to be fed back based on a principal component analysis (PCA) scheme using some of the principal component vectors, and quantize the dimensionally-reduced precoding vector to generated CSI feedback information. Then, the base station may receive the CSI feedback information, and may generate a precoding vector by performing dequantization and inverse PCA transformation on the received CSI feedback information. Finally, the base station may restore a final precoding vector using an artificial neural network.

The present disclosure describes PCA as a representative scheme for dimensionality reduction of the precoding vector. However, exemplary embodiments of the present disclosure are not limited thereto, and for example, various exemplary embodiments of the present disclosure may apply other dimensionality reduction techniques such as independent component analysis (ICA) for dimensionality reduction of the precoding vector. In addition, although the present disclosure proposes performing dimensionality reduction transformation using the PCA scheme for convenience of description, transformation using all principal components may also be possible. In this case, the dimensionality may not be reduced. In addition, the present disclosure provides description in terms of downlink using a base station and a terminal of the mobile communication system, but exemplary embodiments of the present disclosure may be extended and applied to any link configurations or systems by replacing the base station and the terminal with a transmitter and a receiver.

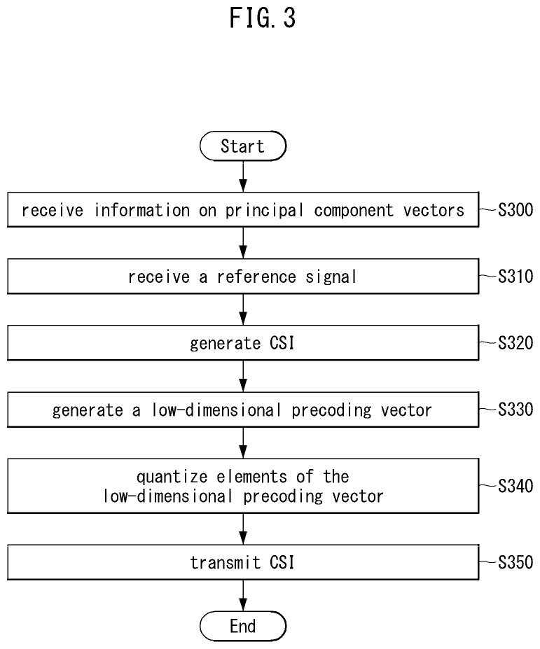

FIG. 3 is a flowchart illustrating a first exemplary embodiment of a method for transmitting CSI in a communication system.

Referring to FIG. 3, the base station may obtain principal component vectors by performing PCA using samples composed of various precoding vectors empirically obtained in a preliminary preparation process. In this case, the number of principal component vectors may be equal to a dimensionality of a precoding vector. Describing the process in more detail, the base station may generate a sample matrix X composed of Nₛₐₘₚₗₑ precoding vectors. Here, Nₛₐₘₚₗₑ may be a positive integer. In this case, a dimensionality of the sample matrix X may be Nₛₐₘₚₗₑ*(2*Ntx). Here, Ntx may be the number of transmit antennas of the base station and may be a positive integer. The base station may obtain matrices U, S, and V as shown in Equation 1 below by performing singular value decomposition (SVD) on the sample matrix X.

X=USV^{T} [Equation 1]

In Equation 1, V may be a right singular matrix and may be a square matrix having a size of Nₛ. Nₛ may be the number of singular values of the sample matrix X. In this case, Nₛ may have a maximum value of 2*Ntx and may be a positive integer. Each column vector of V may be a principal component vector used when performing PCA transformation. In addition, U may be a left singular matrix and may be a square matrix having a size of Nₛ. In addition, S may be a diagonal matrix in which elements on the diagonal are not negative and all the remaining elements are 0.

In Equation 1, all column-wise mean values of the sample matrix X may be 0. In general cases, the sample matrix X not having such restrictions may be expressed as Equation 2 below.

X−μ=USV^{T} [Equation 2]

In Equation 2, μ may be a column-wise mean vector of the sample matrix X. In addition, V may be a unitary matrix and may not be a singular matrix. Each column vector of V may be a principal component. In this case, the number of principal components may have a value of 2*Ntx. In addition, U may be a left singular matrix and may be a square matrix having a size of N^{s}. In addition, S may be a diagonal matrix in which elements on the diagonal are not negative and all the remaining elements are 0. Each diagonal component of S may have an eigen value σᵢ of each corresponding principal component, and may be as shown in Equation 3. Here, i may be 0 to Nₛ−1.

S=diag(σ₀², . . . σ_{2N}_{ₜₓ}₋₁²) [Equation 3]

Meanwhile, an explained variance ratio vᵢ for each principal component may be as shown in Equation 4 below. Here, i may be 0 to Nₛ−1.

$${v}_{i} = \frac{{σ}_{i}^{2}}{{\sum }_{i = 0}^{2 {N}_{tx} - 1} {σ}_{i}^{2}} \qquad [ Equation 4 ]$$

Meanwhile, the base station may transmit information on principal component vectors to the terminal. In this case, the information on principal component vectors may be information on all principal component vectors. Alternatively, the information on principal component vectors may be information on some principal component vectors. The base station may transmit information on principal component vectors to the terminal in a form of higher layer configuration parameters (e.g., radio resource control (RRC) parameters). Then, the terminal may receive the information on principal component vectors from the base station (S300). Accordingly, the terminal may obtain information on all principal component vectors, or information on some principal component vectors.

As described above, the base station may obtain principal component vectors by performing PCA using samples composed of various precoding vectors empirically obtained in a preliminary preparation process. In addition, the base station may share information on the principal component vectors with the terminal in advance. In this case, the base station and the terminal may share information on all principal component vectors or a limited number of principal component vectors.

In order to determine whether it is necessary to transmit information on principal component vectors to the terminal, the base station may request the terminal to report capability information of the terminal. The terminal may include information informing that the terminal has a capability to perform dimensionality reduction using PCA on a precoding vector and a capability to perform quantization in UE capability information, and report the UE capability information to the base station. Accordingly, the base station may receive, from the terminal, the UE capability information including information informing that the terminal has the capability to perform dimensionality reduction and the capability to perform quantization. In addition, the base station may identify the terminal's capability, and may transmit information on principal component vectors to the terminal accordingly.

Meanwhile, the base station may transmit a reference signal such as CSI-RS to the terminal. Then, the terminal may receive the reference signal from the base station (S310), and may generate CSI based on the received reference signal (S320). In this case, the CSI may include rank information, CQI, precoding information, and the like. Thereafter, the terminal may generate a low-dimensional precoding vector by performing dimensionally reduction transformation on the precoding vector in the CSI using a PCA scheme (S330).

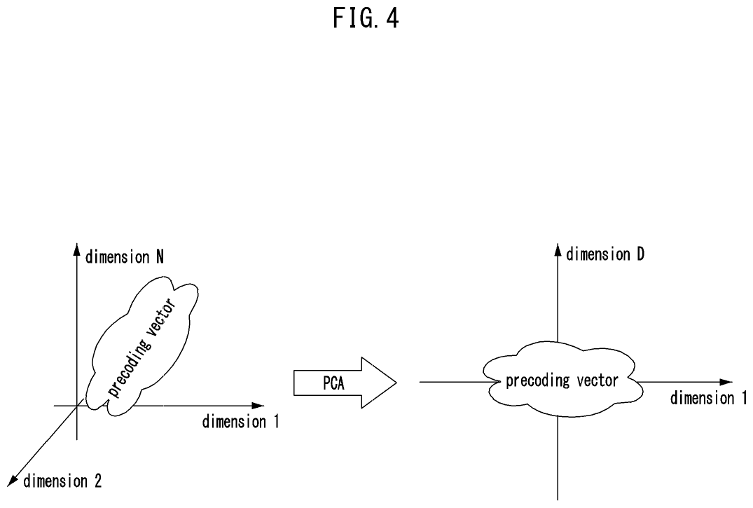

FIG. 4 is a conceptual diagram illustrating a first exemplary embodiment of a process of generating a low-dimensional precoding vector of FIG. 3.

Referring to FIG. 4, the terminal may generate a low-dimensional precoding vector having D dimensions (i.e., dimensionality of D) by performing PCA transformation on an original precoding vector having N dimensions (i.e., dimensionality of N). In this case, N and D may be positive integers, and N may be greater than D.

In this case, the dimensionality N of the original precoding vector may be 2*Ntx. The terminal may generate the low-dimensional precoding vector having the dimensionality of D by selecting D principal component vectors from among the principal component vectors and performing dimensionality reduction transformation using PCA on the original precoding vector. The dimensionality reduction transformation using PCA may be as shown in Equation 5 below.

z=x^{T}V_{D} [Equation 5]

Here, V_{D} may be a transformation matrix having D principal component vectors as column components. Also, x may be the original precoding vector, and z may be the low-dimensional precoding vector.

The terminal may perform dimensionality reduction transformation by applying Equation 5 when all column-wise mean values of the sample matrix are set to 0. In addition, the terminal may apply Equation 5 in the case of dimensionality reduction transformation using D principal components among all principal components. In a general case where there is no such restriction, the terminal may perform dimensionality reduction transformation using Equation 6.

z=(x−μ)^{T}V [Equation 6]

Here, V_{D} may be a transformation matrix having D principal component vectors as column components. Also, x may be the original precoding vector, and z may be the low-dimensional precoding vector. Also, μ may be a column-wise mean vector of the sample matrix X.

Meanwhile, the base station may transmit information (i.e., D) on dimension(s) to be reduced in the N-dimensional original precoding vector to the terminal in advance. In this case, the base station may transmit, to the terminal, information on dimensions(s) to be reduced by using a higher layer configuration parameter (e.g., RRC parameter). In particular, the base station may transmit information on dimension(s) to be reduced in a form of CSI report configuration information (e.g., CSI report configuration) among higher layer configuration parameters (e.g., RRC parameter). Then, the terminal may receive information on dimension(s) to be reduced from the base station through the CSI report configuration information. Accordingly, the terminal may acquire information (e.g., D) on dimension(s) to be reduced.

Referring again to FIG. 3, the terminal may generate a quantized low-dimensional precoding vector by quantizing elements of the low-dimensional precoding vector (S330). The base station may determine the terminal to quantize and report all elements for all dimensions of the low-dimensional precoding vector. Accordingly, the base station may generate configuration information including a quantization report request signal requesting to quantize and report all elements of all dimensions of the low-dimensional precoding vector, and transmit the configuration information including the quantization report request signal to the terminal. The terminal may receive the configuration information including the quantization report request signal from the base station. Accordingly, the terminal may quantize all elements of the low-dimensional precoding vector according to the received configuration information, include them in a channel state information feedback signal, and transmit the same to the base station. The base station may receive the channel state information feedback signal, and obtain all the quantized elements of the low-dimensional precoding vector.

Unlike this, the base station may determine the terminal to quantize and report elements for each dimension of the low-dimensional precoding vector. Accordingly, the base station may generate configuration information including a quantization report request signal requesting to quantize and report elements for each dimension of the low-dimensional precoding vector, and transmit the configuration information including the quantization report request signal to the terminal. Then, the terminal may receive the configuration information including the quantization report request signal from the base station. In addition, the terminal may quantize elements of each dimension of the low-dimensional precoding vector according to the received configuration information, and transmit a channel state information feedback signal including the quantized elements to the base station. Accordingly, the base station may receive the channel state information feedback signal, and obtain the quantized elements of each dimension of the low-dimensional precoding vector.

Here, the terminal may apply one or more of the following schemes as a scheme of quantizing elements of the low-dimensional precoding vector.

(1) Scheme of Quantizing the Elements using a Cumulative Distribution Function (CDF)

The terminal may quantize all elements of all dimensions or elements for each dimension of the low-dimensional precoding vector dimensionally reduced based on the PCA scheme by using a CDF function. In this case, the CDF function may be a CDF function for elements of all dimensions of the dimensionally reduced low-dimensional precoding vector. Alternatively, the CDF function may be a CDF function for elements for each dimension of the dimensionally reduced low-dimensional precoding vector.

In advance, the base station may determine the terminal to quantize all elements for all dimensions of the low-dimensional precoding vector using a CDF and report them. Accordingly, the base station may generate configuration information including a quantization report request signal requesting to quantize and report all elements of all dimensions of the low-dimensional precoding vector using a CDF, and transmit the configuration information including the quantization report request signal to the terminal. Then, the terminal may receive the configuration information including the quantization report request signal from the base station. The terminal may quantize all elements of the low-dimensional precoding vector using the CDF according to the received configuration information, and transmit a channel state information feedback signal including the quantized elements of the low-dimensional precoding vector to the base station. Accordingly, the base station may receive the channel state information feedback signal, and obtain all elements of the low-dimensional precoding vector, which are quantized using the CDF.

Unlike this, the base station may determine the terminal to quantize and report elements for each dimension of the low-dimensional precoding vector. Accordingly, the base station may generate configuration information including a quantization report request signal requesting to quantize and report the elements of each dimension of the low-dimensional precoding vector using a CDF, and may transmit the configuration information including the quantization report request signal to the terminal. Then, the terminal may receive the configuration information including the quantization report request signal from the base station. In addition, the terminal may quantize elements of each dimension of the low-dimensional precoding vector using the CDF according to the received configuration information, and transmit a channel state information feedback signal including the quantized elements to the base station. Accordingly, the base station may receive the channel state information feedback signal, and obtain the elements of each dimension of the low-dimensional precoding vector, which are quantized using the CDF.

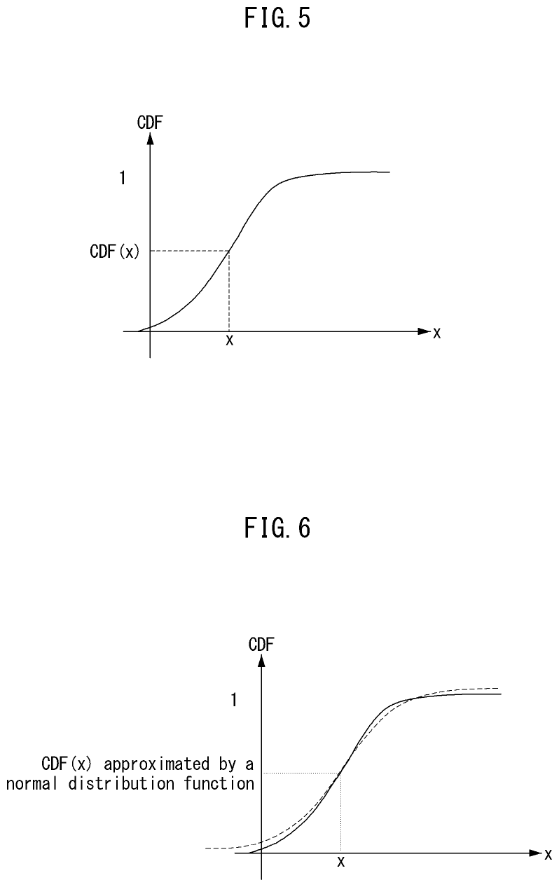

FIG. 5 is a conceptual diagram illustrating a first exemplary embodiment of a process of quantizing elements of the low-dimensional precoding vector of FIG. 3.

Referring to FIG. 5, the terminal may generate output values of CDF(x) by transforming elements of the low-dimensional precoding vector using CDF(x). That is, the terminal may calculate output values respectively corresponding to elements of each dimension by substituting elements of each dimension of the low-dimensional precoding vector into the CDF. In addition, the terminal may perform quantization by applying a uniform quantization scheme of a limited bit length to outputs of the CDF. In this case, the bit lengths for representing elements of all dimensions may be the same. Alternatively, the bit lengths may be different from each other. The base station may transmit the bit length for each dimension to the terminal using a higher layer parameter. Then, the terminal may receive information on the bit length for each dimension from the base station using a higher layer parameter, and the bit length. Here, the uniform quantization may be a scheme of representing a value g having a value between 0 and 1 as a binarized number q as shown in Equation 7 below.

q=└g2^{Q}┘ [Equation 7]

### (2) Scheme of Quantizing Elements by Applying a CDF Approximated by a Normal Distribution

The terminal may quantize each element of the low-dimensional precoding vector dimensionally reduced based the PCA scheme using a CDF approximated to a normal distribution. In this case, the CDF approximated to a normal distribution may be a CDF approximated to a normal distribution for elements of all dimensions of the dimensionally-reduced low-dimensional precoding vector. Alternatively, the CDF approximated to a normal distribution may be a CDF approximated to a normal distribution for elements of each dimension of the dimensionally-reduced low-dimensional precoding vector.

FIG. 6 is a conceptual diagram illustrating a second exemplary embodiment of a process of quantizing elements of the low-dimensional precoding vector.

Referring to FIG. 6, the terminal may approximate a CDF as a normal distribution function having parameters of a mean μ and a variance σ². In FIG. 6, a solid line may denote a CDF, and a dotted line may denote a CDF approximated by a normal distribution function. Here, μ may be a mean of the normal distribution function, and σ² may be a variance of the normal distribution function. In this case, the mean of the normal distribution function may be a mean of elements of all dimensions of the low-dimensional precoding vector. Alternatively, the mean of the normal distribution function may be a mean of elements for each dimension of the low-dimensional precoding vector. In addition, the variance of the normal distribution function may be a variance of elements of all dimensions of the low-dimensional precoding vector. Alternatively, the variance of the normal distribution function may be a variance of elements for each dimension of the low-dimensional precoding vector. Accordingly, the terminal may obtain the mean and variance of elements of all dimensions of the dimensionally-reduced low-dimensional precoding vector in a preliminary preparation process, and apply them to the approximation from the CDF to the normal distribution function. Alternatively, the mean and variance of elements for each dimension may be obtained and applied to the approximation of the normal distribution function of the CDF.

Meanwhile, the base station may obtain the mean and variance of elements of all dimensions of the low-dimensional precoding vector dimensionally reduced in advance, and transmit the mean and variance of elements of all dimensions of the dimensionally-reduced low-dimensional precoding vector to the terminal. In this case, the base station may transmit information on the mean and variance to the terminal using higher layer configuration parameter(s) (e.g., RRC parameter(s)). In particular, the base station may deliver the mean and variance to the terminal according in a form of CSI report configuration information (e.g., CSI report configuration) among higher layer configuration parameters (e.g., RRC parameters). Then, the terminal may receive the mean and variance of elements of all dimensions of the dimensionally reduced low-dimensional precoding vector from the base station. Accordingly, the terminal may obtain the mean and variance of elements of all dimensions of the dimensionally-reduced low-dimensional precoding vector.

Unlike this, the base station may obtain the mean and variance of the elements of each dimension of the low-dimensional precoding vector dimensionally reduced in advance, and may transmit the mean and variance of elements of each dimension of the dimensionally reduced low-dimensional precoding vector to the terminal. In this case, the base station may deliver information on the mean and variance to the terminal using higher layer configuration parameter(s) (e.g., RRC parameter(s)). In particular, the base station may deliver the mean and variance to the terminal in a form of CSI report configuration information (e.g., CSI report configuration) among higher layer configuration parameter(s) (e.g., RRC parameter(s)). Then, the terminal may receive the mean and variance of elements of each dimension of the dimensionally reduced low-dimensional precoding vector from the base station. Accordingly, the terminal may obtain the mean and variance of elements of each dimension of the dimensionally reduced low-dimensional precoding vector.

Accordingly, the terminal may transform and quantize elements of the low-dimensional precoding vector using a CDF(x) approximated to a normal distribution function. That is, the terminal may calculate output values by substituting elements of each dimension of the low-dimensional precoding vector into the CDF approximated to a normal distribution function. In addition, the terminal may quantize each output of the CDF approximated to the normal distribution function by applying a uniform quantization scheme of a limited bit length B(i). Here, B(i) may be a bit length of the i-th dimension. In this case, the bit length may be the same to represent elements of all dimensions. Alternatively, bit lengths of the dimensions may be different from each other. The base station may deliver the bit length for each dimension to the terminal using a higher layer parameter. Then, the terminal may receive and use the bit length for each dimension from the base station using the higher layer parameter. Here, the uniform quantization scheme may be a scheme of represent a value g having a value between 0 and 1 as a binarized number q as in Equation 7.

### (3) Scheme of Quantizing Elements by Applying a Normal Distribution Function

The terminal may generate CSI feedback information by transforming each element of the low-dimensional precoding vector dimensionally reduced based on the PCA to follow a standard normal distribution with a mean of 0 and a variance of 1. The terminal may generate a normal distribution function by using an empirical mean and variance of elements of all dimensions reduced in a preliminary preparation process. Alternatively, the terminal may generate a normal distribution function for each dimension through the empirical mean and variance for each dimension in the preliminary preparation process.

The terminal may quantize each element of the low-dimensional precoding vector dimensionally reduced based on the PCA scheme using the normal distribution function. In this case, the normal distribution function may be a normal distribution function for elements of all dimensions of the dimensionally reduced low-dimensional precoding vector. Alternatively, the normal distribution function may be a normal distribution function for elements of each dimension of the dimensionally reduced low-dimensional precoding vector.

The terminal may generate outputs of the normal distribution function by transforming elements of the low-dimensional precoding vector using the normal distribution function. That is, the terminal may calculate each output corresponding to elements of each dimension by substituting elements of each dimension of the low-dimensional precoding vector into the normal distribution function.

Thereafter, the terminal may quantize elements of each dimension of the dimensionally reduced low-dimensional precoding vector transformed to have a standard normal distribution using a normal distribution function by applying a scalar quantization scheme of a limited bit length. In this case, bit lengths for representing elements of all dimensions may be the same. Alternatively, the bit lengths may be different from each other.

Meanwhile, the terminal may quantize elements of each dimension of the dimensionally reduced low-dimensional precoding vector transformed to have a standard normal distribution using a normal distribution function using a Lloyd Max quantizer. Since the distribution of elements of each dimension is transformed to have a standard normal distribution, a decision threshold and a representation level of the Lloyd Max quantizer for an arbitrary bit length Q may be predetermined.

Meanwhile, when elements of each dimension are quantized, the bit lengths may be the same according to the increasing dimension. Alternatively, the bit lengths may decrease according to the increasing dimension. The bit length of the first dimension may be B(0), and a reduction factor may be R. Then, the terminal may calculate and use the bit length according to the dimension using Equation 8 below for quantization of the dimensionally reduced low-dimensional precoding vector. Here, B(i) may be the bit length of the i-th dimension.

B(i)=┌B(0)Rⁱ┐, i=0, . . . , D−1

For the reduction factor R, for example, (½) may be applied. Here, D may mean the maximum number of dimensions. The base station may set the bit length B(0) of the first dimension and the reduction factor R to the terminal using higher layer parameter(s).

Meanwhile, the bit length of the first dimension may be B(0), the reduction factor may be R, and a reduction unit may be I. Then, the terminal may calculate and use the bit length according to the dimension using Equation 9 below for quantization of the dimensionally reduced low-dimensional precoding vector. Here, B(i) may be the bit length of the i-th dimension.

$$B ( i ) = ⌈ B ( 0 ) {R}^{⌊ \frac{i}{I} ⌋} ⌉ , i = 0 , … , D - 1 \qquad [ Equation 9 ]$$

The base station may set the bit length B(0) of the first dimension, the reduction factor R, and the reduction unit I to the terminal using higher layer parameter(s).

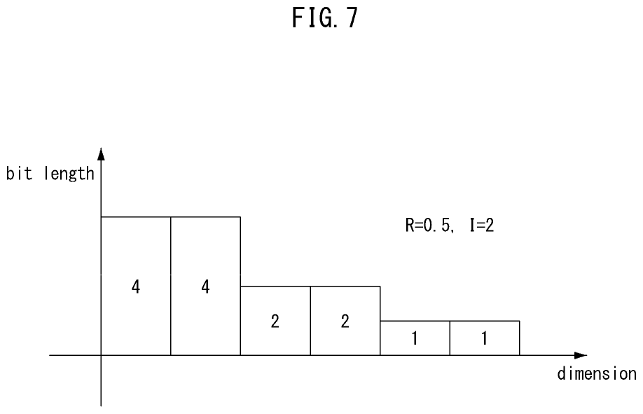

FIG. 7 is a graph illustrating a first exemplary embodiment of a method of setting a bit length for each dimension.

Referring to FIG. 7, the reduction factor may be 0.5 and the reduction unit may be 2. In this case, as the dimension increases, the bit length may start from 4 and decrease to 2 and 1.

Meanwhile, when quantizing elements of each dimension, the terminal may determine and use the bit length based on the importance of each dimension. For example, the terminal may allocate a bit length for each dimension by using information on an explained variance obtained in the PCA process as the importance. The explained variance may be measured using a variance of outputs for each dimension when the transformation is performed using principal components in a given data set. The explained variance may be information indicating how important information is included in each dimension. The explained variance may be a vector with elements equal to the number of principal components. A sum of all elements in the explained variance may be 1. To this end, the explained variance vector v may be v=(v₀, . . . , v_{{D-1}}). A total feedback bit length may be B. Here, B may be a positive integer. In this case, a bit allocation algorithm may be as shown in Table 1 below.

TABLE 1

```
Given : v, B
B <− 0 (i.e., bi = 0 for all i = 0, . . . D−1
for 1 <− 1 to B do
  ${i}^{*} = arg {min}_{i}^{\frac{{v}_{i}}{{2}^{{b}_{i}}}}$
  bi* <− bi* + 1
end for
```

Such the bit allocation algorithm may be a loop that is executed a number of times equal to the given bit length B. In addition, the terminal may search for a dimension in which a quantization error is reduced the most when a quantization step is increased using the bit allocation algorithm, and increase the quantization step of the corresponding dimension.

Referring again to FIG. 3, the terminal may transmit CSI including the quantized low-dimensional precoding vector to the base station (S340). Accordingly, the base station may receive the CSI including the quantized low-dimensional precoding vector from the terminal.

For example, the base station may share information on principal component vectors with the terminal in advance. The base station may configure CSI report configuration including the number S of subbands, the number D of dimensions to be reduced in the precoding vector, and the bit length B for each dimension. The terminal may encode the entire precoding vector into information of S*(D*B) bits and feed back the information to the base station. After receiving this, the base station may reconstruct a residual precoding vector of the subbands through dequantization and inverse PCA transformation.

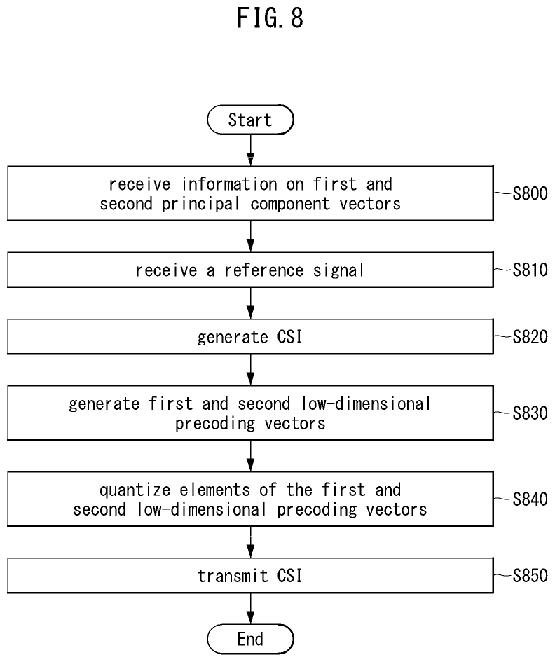

FIG. 8 is a flowchart illustrating a second exemplary embodiment of a method for transmitting CSI in a communication system.

Referring to FIG. 8, the base station may obtain first principal component vectors by performing PCA using samples of one wideband precoding vector composed of various subband precoding vectors empirically obtained in a preliminary preparation process. In this case, the number of the first principal component vectors may be equal to the number of dimensions of the wideband precoding vector. In addition, the base station may obtain second principal component vectors by performing PCA using samples for a residual precoding vector for a precoding vector for each subband with respect to one wideband precoding vector composed of various subband precoding vectors empirically obtained in the preliminary preparation process. In this case, the number of second principal component vectors may be equal to the number of dimensions of the residual precoding vector.

The base station may transmit information on the first principal component vectors and information on the second principal component vectors to the terminal. In this case, information on the first principal component vectors may be information on all the first principal component vectors. Alternatively, the information on the first principal component vectors may be information on some of the first principal component vectors. Also, information on the second principal component vectors may be information on all the second principal component vectors. Alternatively, the information on the second principal component vectors may be information on some of the second principal component vectors.

The base station may transmit information on the first principal component vectors and information on the second principal component vectors to the terminal in a form of higher layer configuration parameter(s) (e.g., RRC parameter(s)). Then, the terminal may receive the information on the first principal component vectors and the information on the second principal component vectors from the base station (S800). The terminal may obtain information on all the first principal component vectors. Alternatively, the terminal may obtain information on some of the first principal component vectors. In addition, the terminal may obtain information on all the second principal component vectors. Alternatively, the terminal may obtain information on some of the second principal component vectors.

As such, the base station may share information on the first principal component vectors and the second principal component vectors with the terminal in advance. In this case, the base station and the terminal may share information on all the first principal component vectors. Alternatively, the base station and the terminal may share information on a limited number of the first principal component vectors. In addition, the base station and the terminal may share information on all the second principal component vectors. Alternatively, the base station and the terminal may share information on a limited number of the second principal component vectors.

Meanwhile, the base station may transmit information on dimension(s) to be reduced in the original wideband precoding vector to the terminal in advance. In this case, the base station may transmit information on dimension(s) to be reduced in the wideband precoding vector to the terminal in a form of CSI report configuration information (e.g., CSI report configuration) among higher layer configuration parameters (e.g., RRC parameters). Then, the terminal may receive information on dimension(s) to be reduced in the wideband precoding vector from the base station through the CSI report configuration information. Accordingly, the terminal may obtain information on dimension(s) to be reduced in the wideband precoding vector.

In addition, the base station may transmit information on dimension(s) to be reduced in the original residual precoding vector to the terminal in advance. In this case, the base station may transmit information on dimension(s) to be reduced in the residual precoding vector to the terminal in a form of CSI report configuration information (e.g., CSI report configuration) among higher layer configuration parameters (e.g., RRC parameters). Then, the terminal may receive information on dimension(s) to be reduced in the residual precoding vector from the base station through the CSI report configuration information. Accordingly, the terminal may obtain information on dimension(s) to be reduced in the residual precoding vector.

Meanwhile, the base station may transmit a reference signal such as CSI-RS to the terminal. Then, the terminal may receive the reference signal from the base station (S810), and the terminal may generate CSI based on the received reference signal (S820). In this case, the CSI may include rank, channel quality (CQI), precoding information, and the like. Thereafter, the terminal may generate one wideband precoding vector composed of a plurality of subband precoding vectors for a plurality of subband precoding vectors in the CSI. In addition, the base station may generate a residual precoding vector for a precoding vector for each subband with respect to the wideband precoding vector.

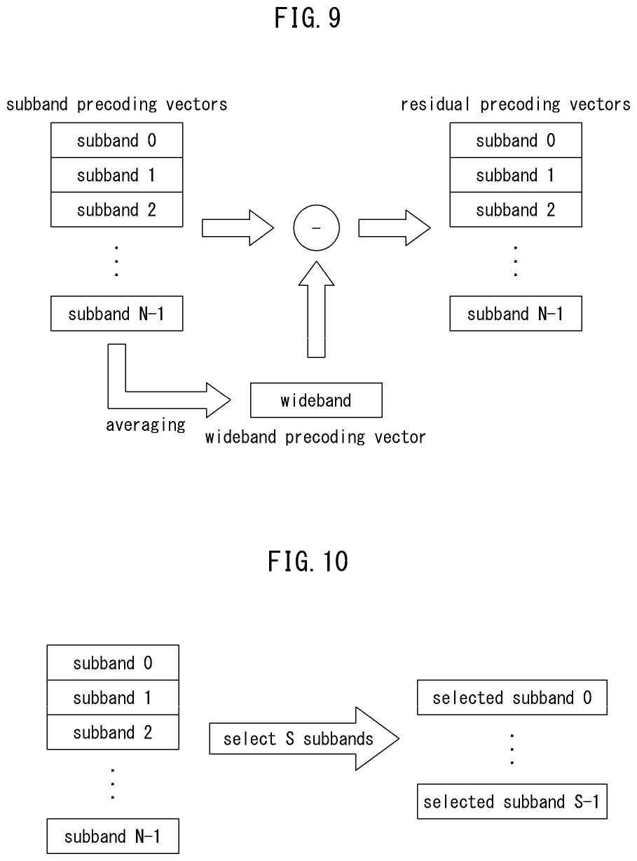

FIG. 9 is a conceptual diagram illustrating a first exemplary embodiment of a process of generating a wideband precoding vector and a residual precoding vector.

Referring to FIG. 9, the terminal may generate a wideband precoding vector by summing and averaging precoding vectors for a plurality of subbands. In addition, the terminal may generate residual precoding vectors by calculating residuals of the respective precoding vectors for the plurality of subbands with respect to the wideband precoding vector.

Referring again to FIG. 8, the terminal may generate a first low-dimensional precoding vector by performing dimensionality reduction transformation on the wideband precoding vector using the first principal component vectors based on the PCA scheme. In addition, the terminal may generate a second low-dimensional precoding vector by performing dimensionality reduction transformation on each of the residual precoding vectors using the second principal component vectors based on the PCA scheme (S830).

In addition, the terminal may generate a quantized first low-dimensional precoding vector by quantizing elements of the first low-dimensional precoding vector. In addition, the terminal may generate a quantized second low-dimensional precoding vector by quantizing elements of the second low-dimensional precoding vector (S840). Then, the terminal may transmit CSI including the quantized first low-dimensional precoding vector and second low-dimensional precoding vectors to the base station (S850). Accordingly, the base station may receive the CSI including the quantized first low-dimensional precoding vectors and second low-dimensional precoding vectors from the terminal. The base station may obtain the first low-dimensional precoding vector and the second low-dimensional precoding vector from the received CSI.

Meanwhile, the base station and the terminal may determine subband(s) to be quantized through dimensionality reduction transformation by using one of 1) a scheme of selecting all or some subbands, 2) a scheme of selecting subbands by defining a start and interval, 3) a scheme of selecting subbands by defining the number of subbands and an interval between the subbands so that the interval between selected subbands is maximized, and 4) a scheme of selecting subbands by defining a list of the subbands.

FIG. 10 is a conceptual diagram illustrating a first exemplary embodiment of a method for selecting some subbands from target subbands.

Referring to FIG. 10, in the mobile communication system, the terminal may select all subbands or some subbands from target subbands. Here, the target subbands may be subbands corresponding to targets for transmitting CSI to the base station, and may be subbands 0 to N. Here, N may be a positive integer. The target subbands may be all subbands constituting a use band used by the base station and the terminal. Alternatively, the target subbands may be some subbands constituting the use band used by the base station and the terminal.

In this case, subbands selected by the terminal from the target subbands may be referred to as selected subbands. Here, the selected subbands may be selected subband 0 to selected subband S−1. Here, S may be a positive integer and may be smaller than N. Accordingly, the terminal may report precoding vectors for the selected subbands to the base station as CSI feedback information. In this case, the terminal may transform each precoding vector into a low-dimensional precoding vector among the precoding vectors of the selected subbands using the PCA scheme. In addition, the terminal may encode them as CSI feedback information by quantizing the low-dimensional precoding vectors for the respective selected subbands.

Thereafter, the terminal may transmit the CSI feedback information including the low-dimensional precoding vectors quantized for the selected subbands to the base station. Then, the base station may receive the CSI feedback information including the low-dimensional precoding vectors quantized for the selected subbands from the terminal. In this case, the base station and the terminal may select subband(s) to be subjected to dimensionality reduction and quantization among the target subbands using one of the following schemes.

### (1) Scheme of Selecting All or Some Subbands

The base station may select all subbands of the entire use band as subbands for which CSI is to be received from the terminal, and may request the terminal to report CSI for all subbands of the entire use band. Then, the terminal may receive the request of reporting CSI for all subbands of the entire use band from the base station. Accordingly, the terminal may transmit CSI for all subbands of the entire use band to the base station. Unlike this, the base station may select subband(s) in which transmission is expected in the future from the entire use band as subbands for which CSI is to be received from the terminal. In addition, the base station may request the terminal to report CSI for the selected subband(s). Then, the terminal may receive the request of reporting CSI for the subbands expected to be used in the future from the base station, and may transmit CSI for the subbands expected to be used in the future to the base station.

### (2) Scheme of Selecting Subbands by Defining a Start and an Interval

The base station may define a start K and an interval J in relation to selected subbands, and may transmit information on the start K and the interval J defined in relation to the selected subbands to the terminal. The terminal may receive information on the start K and the interval J from the base station. Accordingly, the terminal may select S subbands using Equation 10 below.

$$S = ⌈ \frac{N - K}{J} ⌉ \qquad [ Equation 10 ]$$

Here, the bit length B(i) may be K+J*i. i may be one of 0 to S−1. K and J may be positive integers.

(3) Scheme of Defining the Number of Subbands and an Interval Between Subbands so that an Interval Between Selected Subbands is Maximized.

The base station may select the number of subbands for which CSI is to be received from the terminal among all subbands of the entire use band and an interval between subbands, and may transmit information on the selected number of subbands and interval between subbands to the terminal. Then, the terminal may receive information on the selected number of subbands and interval between subbands from the base station. In this case, for example, when receiving information on the number of subbands, the terminal may select subbands that are maximally spaced apart from each other. For example, 12 subbands having indices from 0 to 11 may exist. In this case, when the terminal selects two subbands, the two subbands having indices of 0 and 11 may be determined as the selected subbands.

### (4) Scheme of Defining a List of Selected Subbands

The base station may select subbands from all subbands of the entire use band used by the terminal as subbands for which CSI is to be received from the terminal, and the base station may request the terminal to report CSI on the selected subbands by transmitting a list of the selected subbands to the terminal. Then, the terminal may receive the request of reporting CSI, which includes the list of selected subbands from the base station, and the terminal may transmit CSI on the subbands according to the list to the base station.

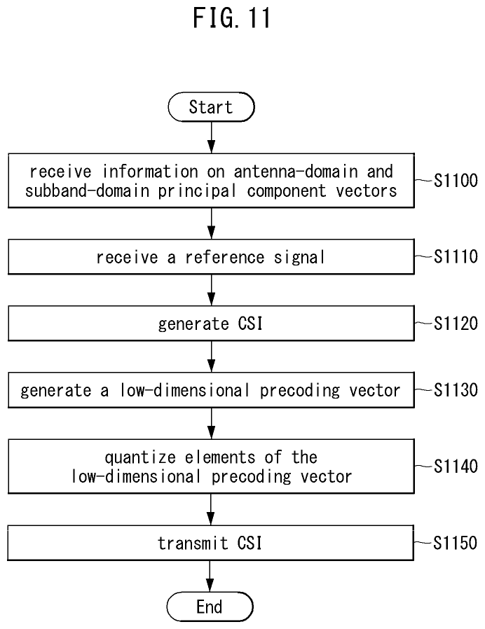

FIG. 11 is a flowchart illustrating a third exemplary embodiment of a method for transmitting CSI in a communication system.

Referring to FIG. 11, the base station may obtain antenna-domain principal component vectors by performing PCA on an antenna axis using samples composed of various subband precoding vectors empirically obtained in a preliminary preparation process. In addition, the base station may obtain subband-domain principal component vectors by performing PCA on a subband axis using samples composed of various subband precoding vectors empirically obtained in the preliminary preparation process. As such, the base station may obtain principal component vectors by performing 2D PCA consisting of the antenna-domain and the subband-domain using samples composed of a plurality of subband precoding vectors in the preliminary preparation process.

The base station may transmit information on the antenna-domain principal component vectors and information on the subband-domain principal component vectors to the terminal. In this case, information on the antenna-domain principal component vectors may be information on all antenna-domain principal component vectors. Alternatively, information on the antenna-domain principal component vectors may be information on some antenna-domain principal component vectors. In addition, information on the subband-domain principal component vectors may be information on all subband-domain principal component vectors. Alternatively, information on the subband-domain principal component vectors may be information on some subband-domain principal component vectors.

The base station may transmit information on the antenna-domain principal component vectors and information on the subband-domain principal component vectors to the terminal in a form of higher layer configuration parameters (e.g., RRC parameters). Then, the terminal may receive information on the antenna-domain principal component vectors and the subband-domain principal component vectors from the base station (S1100). Accordingly, the terminal may obtain information on all antenna-domain principal component vectors. Alternatively, the terminal may obtain information on some antenna-domain principal component vectors. In addition, the terminal may obtain information on all subband-domain principal component vectors. Alternatively, the terminal may obtain information on some subband-domain principal component vectors.

As described above, the base station may share information on the antenna-domain principal component vectors and the subband-domain principal component vectors with the terminal in advance. In this case, the base station and the terminal may share information on all antenna-domain principal component vectors. Alternatively, the base station and the terminal may share information on a limited number of antenna-domain principal component vectors. In addition, the base station and the terminal may share information on all subband-domain principal component vectors. Alternatively, the base station and the terminal may share information on a limited number of subband-domain principal component vectors.

Alternatively, the terminal may obtain antenna-domain principal component vectors by performing PCA on the antenna axis using samples composed of various subband precoding vectors empirically obtained in a preliminary preparation process. In addition, the terminal may obtain subband-domain principal component vectors by performing PCA on the subband axis using samples composed of various subband precoding vectors empirically obtained in a preliminary preparation process. As such, the terminal may obtain principal component vectors by performing 2D PCA consisting of the antenna-domain and the subband-domain using samples composed of a plurality of subband precoding vectors in the preliminary preparation process.

The terminal may transmit information on the antenna-domain principal component vectors and information on the subband-domain principal component vectors to the base station. In this case, information on the antenna-domain principal component vectors may be information on all antenna-domain principal component vectors. Alternatively, information on the antenna-domain principal component vectors may be information on some antenna-domain principal component vectors. In addition, information on the subband-domain principal component vectors may be information on all subband-domain principal component vectors. Alternatively, information on the subband-domain principal component vectors may be information on some subband-domain principal component vectors.

Then, the base station may receive information on the antenna-domain principal component vectors and the subband-domain principal component vectors from the terminal. Accordingly, the base station may obtain information on all antenna-domain principal component vectors. Alternatively, the base station may obtain information on some antenna-domain principal component vectors. In addition, the base station may obtain information on all subband-domain principal component vectors. Alternatively, the base station may obtain information on some subband-domain principal component vectors.

As described above, the terminal may share information on the antenna-domain principal component vectors and the subband-domain principal component vectors with the bases station in advance. In this case, the base station and the terminal may share information on all antenna-domain principal component vectors. Alternatively, the base station and the terminal may share information on a limited number of antenna-domain principal component vectors. In addition, the base station and the terminal may share information on all subband-domain principal component vectors. Alternatively, the base station and the terminal may share information on a limited number of subband-domain principal component vectors.

The base station or the terminal may generate a sample matrix X composed of Nₛₐₘₚₗₑ precoding vectors in order to obtain principal component vectors. Here, Nₛₐₘₚₗₑ may be a positive integer. In this case, a dimensionality of the sample matrix X may be Nₛₐₘₚₗₑ*(2*Ntx). Here, Ntx may be the number of transmit antennas of the base station and may be a positive integer. The base station or the terminal may obtain an antenna-domain sample matrix Xₐₙₜ from the sample matrix X. In addition, the base station or terminal may perform SVD on the antenna-domain sample matrix Xₐₙₜ to obtain matrices Uₐₙₜ, Sₐₙₜ, and Vₐₙₜ as shown in Equation 11 below.

Xₐₙₜ−μₐₙₜ=UₐₙₜSₐₙₜVₐₙₜ^{T} [Equation 11]

In Equation 11, the matrix Vₐₙₜ may be a unitary matrix. Each column vector of the matrix Vₐₙₜ may be a principal component vector used when performing PCA transformation. Also, the matrix Uₐₙₜ may be a left singular matrix and may be a square matrix having a size of Nₛ. Nₛ is the number of singular values of the sample matrix X. In addition, the matrix Sₐₙₜ may be a diagonal matrix in which elements on the diagonal are not negative and all the remaining elements are 0.

Each diagonal component of the matrix Sₐₙₜ may have a corresponding eigen value σ_{ant,i} of each principal component, and may be as shown in Equation 3. Here, i may be 0 to Nₛ−1.

Sant=diag(σ_{ant,0}², . . . σ_{ant,2N}_{ₜₓ}₋₁²) [Equation 12]

Meanwhile, the explained variance ratio v_{ant,i} for each principal component may be as shown in Equation 13 below. Here, i may be 0 to N₂−1.

$${v}_{ant , i} = \frac{{σ}_{ant , i}^{2}}{{\sum }_{i = 0}^{2 {N}_{tx} - 1} {σ}_{ant , i}^{2}} \qquad [ Equation 13 ]$$

Meanwhile, the base station or the terminal may obtain a subband-domain sample matrix X_{sb} from the sample matrix X. In addition, the base station or the terminal may perform SVD on the subband-domain sample matrix X_{sb} to obtain matrices U_{sb}, S_{sb}, and V_{sb} as shown in Equation 14 below.

X_{sb}−μ_{sb}=U_{sb}S_{sb}V_{sb}^{T} [Equation 14]

In Equation 14, the matrix V_{sb} may be a unitary matrix. Each column vector of the matrix V_{sb} may be a principal component vector used when performing PCA transformation. Also, the matrix U_{sb} is a left singular matrix and may be a square matrix having a size of Nₛ. Nₛ is the number of singular values of the sample matrix X. In addition, the matrix S_{sb} may be a diagonal matrix in which elements on the diagonal are not negative and all the remaining elements are 0.

Each diagonal component of the matrix S_{sb} may have a corresponding eigen value σ_{sb,i} of each principal component, and may be as shown in Equation 15. Here, i may be 0 to Nₛ−1.

Ssb=diag(σ_{sb,0}², . . . σ_{sb,2N}_{ₜₓ}₋₁²) [Equation 15]

Meanwhile, the explained variance ratio v_{sb,i} for each principal component may be as shown in Equation 16 below. Here, i may be 0 to Nₛ−1.

$${y}_{sb , i} = \frac{{σ}_{sb , i}^{2}}{{\sum }_{i = 0}^{2 {N}_{tx} - 1} {σ}_{sb , i}^{2}} \qquad [ Equation 16 ]$$

Meanwhile, the base station may transmit information on dimension(s) to be reduced in the precoding vector to the terminal in advance. Here, the information on dimension(s) to be reduced in the precoding vector may be information indicating that 2-dimensional PCA is to be performed. In this case, the base station may transmit the information on dimension(s) to be reduced in the precoding vector to the terminal in a form of CSI report configuration information (e.g., CSI report configuration) among higher layer configuration parameters (e.g., RRC parameters). Then, the terminal may receive information on dimension(s) to be reduced in the precoding vector from the base station through the CSI report configuration information. Accordingly, the terminal may obtain information on dimension(s) to be reduced in the precoding vector. Here, the dimension(s) to be reduced in the precoding vector may be 2.

Meanwhile, the base station may transmit a reference signal such as CSI-RS to the terminal. Then, the terminal may receive the reference signal from the base station (S1110), and generate CSI based on the received reference signal (S1120). In this case, the CSI may include rank, CQI, precoding information, and the like. Thereafter, the terminal may generate a low-dimensional precoding vector by dimensionally reducing and transforming a precoding vector using antenna-domain principal component vectors and subband-domain principal component vectors using the PCA scheme (S1130). In this case, the low-dimensional precoding vector z may be equal to Equation 17 below, and a dimensionality thereof may be 2Ntx x Nsb.

Z=(((W^{T}−μₐₙₜ)Vₐₙₜ)^{T}−μ_{sb})V_{sb} [Equation 17]

The terminal may generate a quantized low-dimensional precoding vector by quantizing elements of the low-dimensional precoding vector (S1140), and may transmit CSI including the quantized low-dimensional precoding vector to the base station (S1150). Accordingly, the base station may receive the CSI including the quantized low-dimensional precoding vector from the terminal, and may obtain the low-dimensional precoding vector from the received CSI.

Meanwhile, when quantizing elements for each dimension of the low-dimensional precoding vector obtained through two-dimensional PCA transformation, the terminal may use a bit length determined based on importance of each dimension. For example, the terminal may be able to use an explained variance for each dimension as importance information for each dimension among the two dimensions. An explained variance vector V for the two-dimensional PCA transform may be denoted by vₐₙₜ×v_{sb}, where the operator × may be a Cartesian product representing a product set. V may be a matrix having a dimensionality of 2Ntx*Nsb. The total feedback bit length may be B. Here, B may be a positive integer. In this case, a bit allocation algorithm may be as follows.

TABLE 2

```
Given : V, B
B <− 0 (i.e., b_{i,j} = 0 for all i = 0, . . . D−1
for 1 <− 1 to B do
  $( {i}^{*} , {j}^{*} ) = arg {min}_{( i , j )}^{\frac{{v}_{i , j}}{{2}^{{b}_{i , j}}}}$
  b_{i*,j*} <− b_{i*,j*} + 1
end for
```

Such the bit allocation algorithm may be a loop that is executed a number of times equal to the given bit length B. In addition, the terminal may search for a dimension in which a quantization error is reduced the most when a quantization step is increased using the bit allocation algorithm, and increase the quantization step of the corresponding dimension.

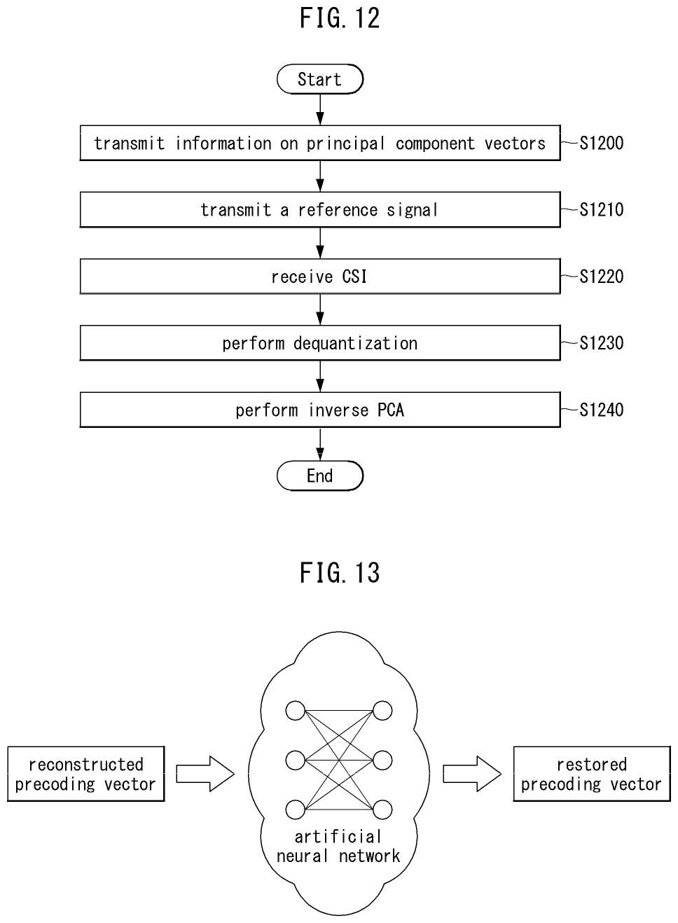

FIG. 12 is a flowchart illustrating a first exemplary embodiment of a method for receiving CSI in a communication system.

Referring to FIG. 12, the base station may obtain principal component vectors by performing PCA using samples composed of various precoding vectors empirically obtained in a preliminary preparation process. The base station may transmit information on the principal component vectors to the terminal (S1200). In this case, information on the principal component vectors may be information on all principal component vectors. Alternatively, information on the principal component vectors may be information on some principal component vectors. The base station may transmit information on the principal component vectors to the terminal in a form of higher layer configuration parameters (e.g., RRC parameters). Then, the terminal may receive information on the principal component vectors from the base station. Accordingly, the terminal may obtain information on all principal component vectors. Alternatively, the terminal may obtain information on some principal component vectors.

Meanwhile, the base station may transmit a reference signal such as CSI-RS to the terminal (S1210). Then, the terminal may receive the reference signal from the base station, and generate CSI based on the received reference signal. In this case, the CSI may include rank, CQI, precoding information, and the like. Thereafter, the terminal may generate a low-dimensional precoding vector by performing dimensionality reduction transformation on a precoding vector in the CSI using the PCA scheme.

The terminal may generate a quantized low-dimensional precoding vector by quantizing elements of the low-dimensional precoding vector, and may transmit CSI including the quantized low-dimensional precoding vector to the base station. Accordingly, the base station may receive the CSI including the quantized low-dimensional precoding vector from the terminal.

Thereafter, the base station may dequantize the CSI including the quantized low-dimensional precoding vector to obtain the low-dimensional precoding vector (S1230). In this case, the base station may perform dequantization in at least one of the following schemes.

(1) Scheme of Converting a Received Value of Each Element to a Value Between 0 and 1 by Performing Uniform Dequantization Thereon, and then Restoring it into a Compressed Value using an Inverse Cumulative Distribution Function (ICDF)

In the uniform dequantization scheme, the terminal may perform dequantization as shown in Equation 18 below when a quantized received value b expressed by Q bits for each dimension is given.

$$\hat{u} = \frac{1}{{2}^{Q + 1}} + \frac{b}{{2}^{Q}} \qquad [ Equation 18 ]$$

The terminal may obtain a low-dimensional precoding vector ĝ by using an ICDF as shown in Equation 19 below for the dequantized value û.

$$\hat{g} = ICDF ( \hat{u} \qquad [ Equation 19 ]$$

(2) Scheme of Performing Dequantization in Response to the Quantization Scheme for Each Element of the Terminal, and then Restoring a Compressed Value by Applying a Linear Least Square Error Scheme Based on the Bussgang Theory

In the linear least square error scheme based on the Bussgang theory, the base station may calculate the dequantized value û through Equation 20 below when a quantized received vector q of dimensions having the same bit length Q is given.

$$\hat{u} = \frac{{γ}_{Q}}{{ψ}_{Q}} q \qquad [ Equation 20 ]$$

In Equation 20, γ_{Q} and ψ_{Q} may be constants for a Q-bit quantizer, and may be calculated through Equations 21 and 22 below.

$${γ}_{Q} = {\sum }_{i = 1}^{Q} \frac{{q}_{i}}{\sqrt{2 π}} \{ exp ( - \frac{{τ}_{i - 1}^{2}}{2} ) - exp ( - \frac{{τ}_{i}^{2}}{2} ) \} \qquad [ Equation 21 ]$$

$${ψ}_{Q} = {\sum }_{i = 1}^{Q} {q}_{i}^{2} \{ Φ ( {τ}_{i} ) - Φ ( {τ}_{i - 1} ) \} \qquad [ Equation 22 ]$$

In Equations 21 and 22, qᵢ may represent the i-th quantized value of the quantizer. τᵢ may represent the i-th threshold. Also, Φ(τᵢ) may represent a CDF of a normal probability distribution.

The base station may restore a compressed value by performing inverse normalization on the vector û restored based on the bus strength theory using the mean and variance as shown in Equation 23.

\hat{g}=\sqrt{σ²}×û+μ [Equation 23]

In Equation 23, μ and σ² may be vectors having a mean and a variance of each dimension as elements. In Equation 23, x may mean a Hadamard product.

Meanwhile, the base station may generate a precoding vector by performing inverse PCA on the dequantized low-dimensional precoding vectors (S1240). The base station may generate an original precoding vector having a dimensionality of N by performing inverse PCA transformation on the low-dimensional precoding vector having a dimensionality of D. In this case, N and D may be positive integers, and N may be greater than D. In this case, the dimensionality N of the original precoding vector may be 2*Ntx. The terminal may generate the original precoding vector by selecting D principal component vectors from among the principal component vectors and performing inverse PCA transformation as shown in Equation 24. The inverse PCA transformation may be as shown in Equation 24 below.

\hat{x}=zV_{D}^{T} [Equation 24]

Here, V_{D} may be a transformation matrix having D principal component vectors as column components. \hat{x} may be a restored original precoding vector, and z may be a low-dimensional precoding vector. Meanwhile, the base station may perform inverse dimensionality reduction transformation by applying Equation 24 when all column-wise mean values of the sample matrix are set to 0. In addition, the base station may apply Equation 24 when performing inverse dimensionality reduction transformation using D principal components among all principal components. The base station may perform inverse dimensionality reduction transformation using Equation 25 in a general case where there is no such restriction.

\hat{x}=zV^{T}+μ [Equation 25]

V may be a transformation matrix having D principal component vectors as column components. \hat{x} may be a restored original precoding vector, and z may be a low-dimensional precoding vector. Also, μ may be a column-wise mean vector of the sample matrix X.

Meanwhile, the base station may perform inverse dimensionality reduction transformation using Equation 26 when the terminal generates feedback information using 2-dimensional PCA.

\hat{x}(ZV_{sb}^{t}+μ_{sb})^{T}Vₐₙₜ^{T}+μₐₙₜ [Equation 26]

Meanwhile, the base station may reconstruct the recovered precoding vector using the CSI feedback information received from the terminal. In addition, the base station may obtain a final reconstructed precoding vector from the reconstructed precoding vector using an artificial neural network for channel restoration. Thereafter, the base station may communicate with the terminal using the recovered precoding vector or the restored precoding vector.

FIG. 13 is a diagram illustrating a first exemplary embodiment of a method of restoring a precoding vector based on an artificial neural network.

Referring to FIG. 13, the base station may include an artificial neural network for channel restoration. Accordingly, the artificial neural network may receive the 2*Ntx-dimensional reconstructed precoding vector and generate a 2*Ntx-dimensional restored precoding vector. For example, the artificial neural network may be an artificial neural network in various forms such as a fully-connected neural network (FCNN), a multi-layer perceptron (MLP), a convolutional neural network (CNN), or a transformer.

FIG. 14 is a diagram illustrating a second exemplary embodiment of a method of restoring a precoding vector based on an artificial neural network.

Referring to FIG. 14, the base station may include an artificial neural network for channel restoration. Accordingly, the artificial neural network may receive each recovered subband precoding vector having a dimensionality of S*2*Ntx and generate each restored subband precoding vector having a dimensionality of N*2*Ntx. For example, the artificial neural network may be an artificial neural network in various forms such as FCNN, MLP, CNN, or transformer.

Meanwhile, according to the present disclosure, the base station may reconstruct a precoding vector by receiving CSI fed back from the terminal in the mobile communication system. In this case, it may be assumed that elements for each dimension are quantized with a bit length determined based on the importance of each dimension. The base station may perform dequantization using the bit length. Information on the bit length for quantization may be shared in a CSI feedback configuration procedure. Alternatively, information on the bit length for quantization may be independently determined by the base station.

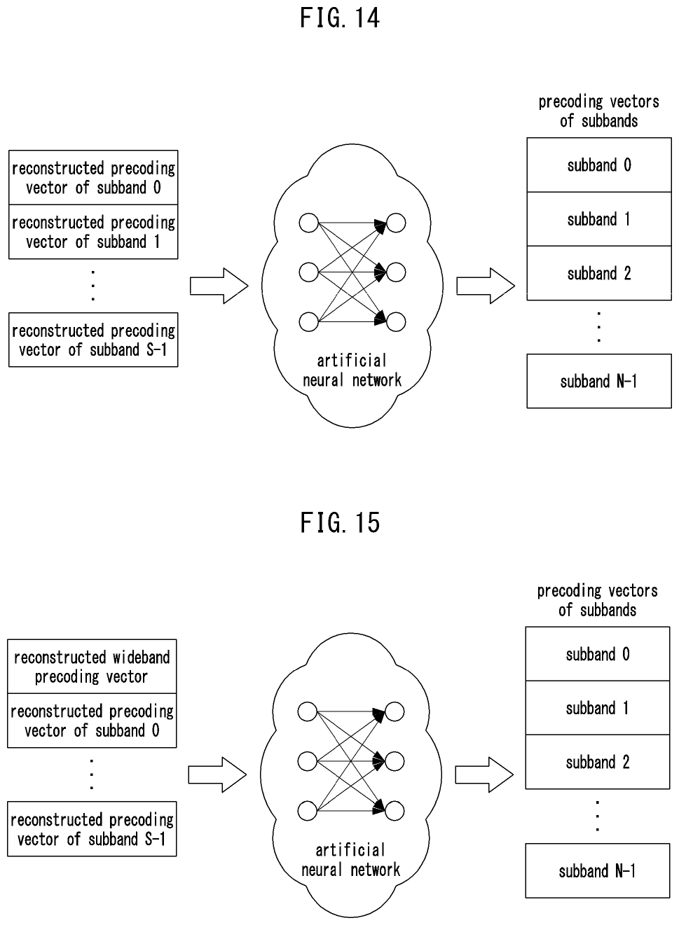

FIG. 15 is a diagram illustrating a third exemplary embodiment of a method of restoring a precoding vector based on an artificial neural network.

Referring to FIG. 15, the base station may include an artificial neural network for channel restoration. Accordingly, the artificial neural network may receive a recovered wideband precoding vector and recovered residual precoding vectors, and generate restored subband precoding vectors. In this case, the base station may reconstruct an entire band precoding vector through interpolation using the subband precoding vectors. Meanwhile, when the wideband precoding vector and the residual precoding vector for each subband are recovered, the artificial neural network may derive a precoding vector for each subband by combining them. As described above, the entire band precoding vector may be obtained through the artificial neural network, and in this case, the dimensionality of input may be equal to N*2*Ntx.

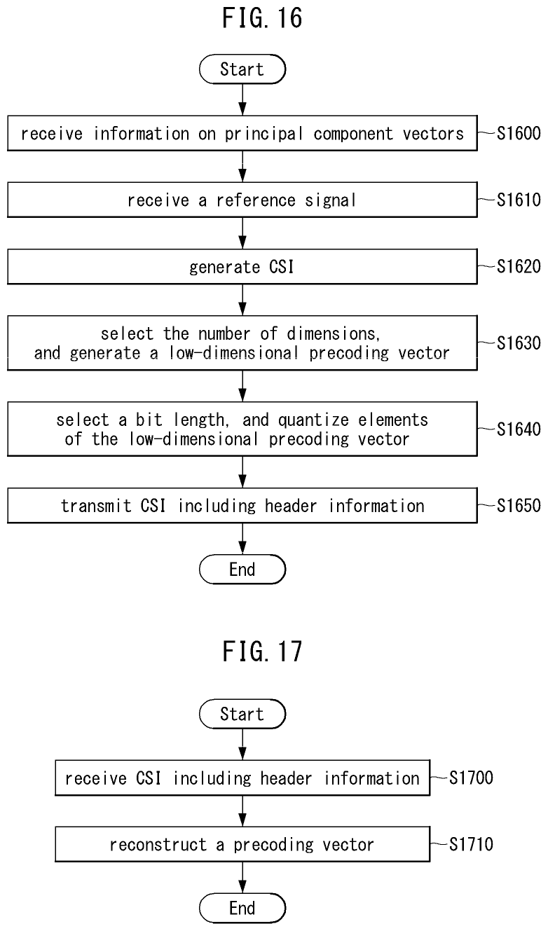

FIG. 16 is a flowchart illustrating a third exemplary embodiment of a method for transmitting CSI in a communication system.

Referring to FIG. 16, the base station may obtain principal component vectors by performing PCA using samples of various subband precoding vectors empirically obtained in a preliminary preparation process. In this case, the number of principal component vectors may be equal to the number of dimensions of the subband precoding vector. The base station may transmit information on the principal component vectors to the terminal. In this case, information on the principal component vectors may be information on all principal component vectors. Alternatively, information on the principal component vectors may be information on some principal component vectors.

The base station may transmit information on the principal component vectors to the terminal in a form of higher layer configuration parameters (e.g., RRC parameters). Then, the terminal may receive information on the principal component vectors from the base station (S1600), and may obtain information on all principal component vectors. Alternatively, the terminal may obtain information on some principal component vectors.

Meanwhile, the base station may configure CSI report configuration information including the number S of subbands, the number of dimension(s) to be reduced in the precoding vector, and the bit length B for each dimension. In this case, the base station may additionally include a reduction factor R of the bit length and a reduction unit I in the CSI report configuration information. In addition, the base station may transmit the CSI report configuration information including such the information to the terminal. Accordingly, the terminal may receive the CSI report configuration information. In addition, the terminal may obtain the number S of subbands, the number D of dimension(s) to be reduced in the precoding vector, the bit length B for each dimension, the reduction factor R of the bit length, and the reduction unit I.

Meanwhile, the base station may transmit a reference signal such as CSI-RS to the terminal. The terminal may receive the reference signal from the base station (S1610), and generate CSI based on the received reference signal (S1620). In this case, the CSI may include rank, CQI, precoding information, and the like. Thereafter, the terminal may select the number of dimensions to be reduced for the a plurality of subband precoding vectors form the CSI, and perform dimensionality reduction transformation through PCA using principal component vectors to generate low-dimensional precoding vectors (S1630).

Then, the terminal may select a bit length for each dimension and quantize elements of the low-dimensional precoding vector using the selected bit length to generate quantized low-dimensional precoding vectors (S1640). In addition, the terminal may generate CSI including the quantized low-dimensional precoding vectors and a header including information on the number of reduced dimensions and the bit length for each dimension. Thereafter, the terminal may transmit the CSI including the header and the quantized low-dimensional precoding vectors to the base station (S1650). Accordingly, the base station may receive the CSI from the terminal. As a result, the base station may identify the number of reduced dimensions and the bit length information for each dimension, and the base station may restore the original precoding vector using the number of reduced dimensions and the bit length for each dimension.

FIG. 17 is a flowchart illustrating a second exemplary embodiment of a method for receiving CSI in a communication system.

Referring to FIG. 17, the terminal may transmit CSI including, as a header, information on the number of reduced dimensions and the bit length for each dimension to the base station. Accordingly, the base station may receive the CSI from the terminal (S1700). As a result, the base station may identify the number of reduced dimensions and the bit length for each dimension, and may restore the original precoding vector using the reduced number of dimensions and the bit length for each dimension (S1710).

Meanwhile, the base station may select the number S of subbands for which CSI is to be received from the terminal among all subbands of the entire use band and an interval between subbands. In this case, the base station may select the maximum separation distance as the interval between subbands, and may transmit information on the selected number of subbands and the interval between subbands to the terminal. Then, the terminal may receive information on the selected number of subbands and interval between subbands from the base station. For example, the terminal may determine S subbands spaced apart the most as subbands for which CSI is to be transmitted. In addition, the base station may determine the number D of dimensions to be reduced in the precoding vector and the bit length B for each dimension.

In addition, the base station may generate CSI report configuration information including the selected number S of subbands, the interval between subbands, the number D of dimensions, the bit length B for each dimension, the reduction factor R of bit length, and the reduction unit I, and transmit the CSI report configuration information to the terminal. Accordingly, the terminal may receive the CSI report configuration information. In addition, the terminal may obtain the selected number S of subbands, the number D of dimensions to be reduced in the precoding vector, the bit length B for each dimension, the reduction factor R of the bit length, and the reduction unit I.

Accordingly, the terminal may determine the number S of subbands, the number D of dimensions to be reduced, and the bit length for each dimension, configure CSI feedback information including them as header information, and transmit the CSI feedback information to the base station. The base station may receive the CSI feedback information including the header information from the terminal, and may restore the original precoding vector using the number of reduced dimensions and the bit length for each dimension.

Meanwhile, the base station may transmit first dimension information on dimension(s) to be reduced in the original wideband precoding vector to the terminal in advance. In this case, the base station may transmit the first dimension information to the terminal in a form of CSI report configuration information (e.g., CSI report configuration) among higher layer configuration parameters (e.g., RRC parameter). Then, the terminal may receive the first dimension information from the base station through the CSI report configuration information. Accordingly, the terminal may obtain information on the dimension(s) to be reduced in the wideband precoding vector.

In addition, the base station may transmit second dimension information on dimension(s) to be reduced in the original residual precoding vector to the terminal in advance. In this case, the base station may transmit the second dimension information to the terminal in a form of CSI report configuration information (e.g., CSI report configuration) among higher layer configuration parameters (e.g., RRC parameter). Then, the terminal may receive the second dimension information from the base station through the CSI report configuration information. Accordingly, the terminal may obtain information on the dimension(s) to be reduced in the residual precoding vector.

In addition, the base station may select the number S of subbands for which CSI is to be received from the terminal among all subbands of the entire use band and an interval between subbands. In this case, the base station may select the maximum separation distance as the interval between subbands, and may transmit information on the selected number of subbands and the interval between subbands to the terminal. Then, the terminal may receive information on the selected number of subbands and interval between subbands from the base station. For example, the terminal may determine S subbands spaced apart the most as subbands for which CSI is to be transmitted. In addition, the base station may determine the number D1 of dimensions to be reduced in the wideband precoding vector and the bit length B1(i) for each dimension. In addition, the base station may determine the number D2 of dimensions to be reduced in the wideband precoding vector and the bit length B2(i) for each dimension.

The base station may generate CSI report configuration information including the number S of subbands, the interval between subbands, the number D1 of dimensions to be reduced, the number D2 of dimensions to be reduced, the bit length B1(i), the bit length B2(i), the reduction factor R of bit length, and the reduction unit I, and transmit the CSI report configuration information to the terminal. Accordingly, the terminal may receive the CSI report configuration information, and may obtain the information on the number S of subbands, the interval between subbands, the number D1 of dimensions to be reduced, the number D2 of dimensions to be reduced, the bit length B1(i), the bit length B2(i), the reduction factor R of bit length, and the reduction unit I.

Accordingly, the terminal may finally determine the number S of subbands, the interval between subbands, the number D1 of dimensions to be reduced, the number D2 of dimensions to be reduced, the bit length B1(i), the bit length B2(i), the reduction factor R of bit length, and the reduction unit I, configure CSI feedback information including the determined information as header information, and transmit the CSI feedback information to the base station.

The base station may receive the CSI feedback information including, as header information, the number S of subbands, the interval between subbands, the number D1 of dimensions to be reduced, the number D2 of dimensions to be reduced, the bit length B1(i), the bit length B2(i), the reduction factor R of bit length, and the reduction unit I. Then, the base station may restore the original precoding vector using information on the number of dimensions to be reduced and the bit length for each dimension.

As described above, the base station may share the first and second principal component vectors with the terminal in advance, and may configure CSI report configuration information including the number S of subbands S, the numbers (D1 and D2) of dimensions to be reduced in the wideband precoding vector and the subband residual precoding vectors, and the bit lengths (B1 and B2) for each dimension. The terminal may encode the entire precoding vectors into information of D1*B1+S*(D2*B2) bits, and feed back the information to the base station. The base station may receive the encoded precoding vectors and reconstruct the wideband precoding vector and the subband residual precoding vectors through dequantization and inverse PCA transformation. As such, the base station may determine configurations for subbands for which CSI is encoded and reported by the terminal based on a channel environment and/or reception quality, and configure CSI report configuration information including them as higher layer parameters.

Meanwhile, the base station may reconstruct the recovered precoding vector using the CSI feedback information received from the terminal. In addition to this, the base station may obtain a final restored precoding vector from the reconstructed precoding vector using an artificial neural network for channel restoration.

Meanwhile, according to the present disclosure, the terminal may infer an expected restoration quality for each configuration, and may determine a configuration having the best expected restoration quality among configurations. In this case, the base station may use an AI (artificial intelligence) model to restore the recovered precoding vector. In this case, the terminal may receive the AI model from the base station. Alternatively, the terminal may be loaded with a separately trained AI model in advance.

In this case, as an exemplary embodiment, the terminal may report, to the base station, capability information including information on whether the terminal is able to infer an expected restoration quality, information on whether the terminal is able to perform a restoration process using an AI model, and information on whether the terminal has an AI model. The base station may receive the capability information, and may determine whether to allow the terminal to dynamically determine CSI feedback configuration information based on the received capability information of the terminal.

Meanwhile, according to the present disclosure, the base station or terminal may derive principal component vectors by independently performing PCA using a non-shared training data set. Thereafter, the base station or the terminal may derive final principal component vectors using reference principal component vectors derived using a shared reference data set. A terminal according to the present disclosure may generate CSI feedback information using the final principal component vectors, and the base station may use the final principal component vectors to decode the received CSI feedback information.

As an exemplary embodiment of the present disclosure, the base station or terminal may determine a rotation transformation matrix Ω for transforming principal component vectors derived by each entity to be similar to reference principal component vectors through an orthogonal Procrustes problem such as Equation 27 below.

R=arg min_{Ω}∥AΩ−B∥_{F}, subject to R^{T}R=I [Equation 27]

In Equation 27, ∥ ∥_{F} is a Frobenious norm, and may mean a sum of square values of all elements of the matrix. The base station or terminal may perform rotation transformation using the rotation transformation matrix Ω derived from the principal component vectors derived by each entity. In addition, the base station or terminal may use the principal component vectors obtained through the rotation transformation as the final principal component vectors. It may be assumed that the final principal component vectors determined in the above-described manner have a similar direction and size, assuming that the base station and terminal use training data having a similar distribution.

In the present disclosure, the principal component may be one-dimensional, or may be a principal component for each dimension derived through 2-dimensional PCA on the frequency and subband axes. The base station or the terminal may derive the final principal component vector through rotation transformation by deriving the rotation transformation matrix for each dimension from the principal component vector for each dimension.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
receiving a reference signal from a base station;
generating a precoding vector based on the reference signal;
generating a low-dimensional precoding vector by performing dimensionality reduction transformation on the precoding vector;
quantizing the low-dimensional precoding vector; and
transmitting the quantized low-dimensional precoding vector to the base station.

2. The method according to claim 1, further comprising: receiving information on principal component vectors from the base station, wherein in the generating of the low-dimensional precoding vector, the low-dimensional precoding vector is generated by performing dimensionality reduction transformation on the precoding vector through a principal component analysis scheme using the principal component vectors.

3. The method according to claim 2, wherein information on the principal component vectors is received from the base station in a form of higher layer configuration parameter(s).

4. The method according to claim 1, wherein in the generating of the low-dimensional precoding vector, the low-dimensional precoding vector is generated by performing dimensionality reduction transformation on the precoding vector through an independent component analysis scheme.

5. The method according to claim 1, wherein the quantizing of the low-dimensional precoding vector comprises:
transforming elements of the low-dimensional precoding vector by applying a distribution function; and
quantizing the elements transformed through the distribution function.

6. The method according to claim 5, wherein the distribution function is one of a cumulative distribution function (CDF) function, a CDF function approximated as a normal distribution function, or a normal distribution function.

7. The method according to claim 5, wherein in the quantizing of the elements transformed through the distribution function, the quantizing is performed using at least one of a uniform quantization scheme, a scalar quantization scheme, or a quantization scheme using a Lloyd Max quantizer.

8. The method according to claim 1, wherein in the quantizing of the low-dimensional precoding vector, elements of all dimensions of the low-dimensional precoding vector or elements of each dimension of the low-dimensional precoding vector are quantized.

9. The method according to claim 8, wherein when the elements of each dimension of the low-dimensional precoding vector are quantized, a bit length is maintained to be identical between dimensions or decreases as the dimension increases.

10. The method according to claim 8, wherein when the elements of each dimension of the low-dimensional precoding vector are quantized, a bit length for each dimension is determined according to importance based on an explained variance of each dimension.

11. A method of a terminal, comprising:
receiving, from a base station, information on reporting target subbands among subbands of a use band;
receiving a reference signal from the base station;
generating precoding vectors for the reporting target subbands based on the reference signal;
generating low-dimensional precoding vectors by performing dimensionality reduction transformation on the precoding vectors;
quantizing the low-dimensional precoding vectors; and
transmitting the quantized low-dimensional precoding vectors to the base station.

12. The method according to claim 11, wherein the information on the reporting target subbands may be one of: information indicating all of the subbands of the use band as the reporting target subbands, information indicating subbands expected to be used among the subbands of the use band as the reporting target subbands, information indicating an index of a starting subband among the subbands of the use band and an interval between subbands, or information indicating a number of the reporting target subbands and an interval between subbands.

13. The method according to claim 11, wherein the generating of the low-dimensional precoding vectors comprises:
decomposing the precoding vectors for the reporting target subbands into a wideband precoding vector and a residual precoding vector for each subband;
generating a wideband low-dimensional precoding vector from among the low-dimensional precoding vectors by performing dimensionality reduction transformation on the wideband precoding vector using first principal component vectors; and
generating a low-dimensional precoding vector for each subband from among the low-dimensional precoding vectors by performing dimensionality reduction transformation on the residual precoding vector for each subband using second principal component vectors.

14. The method according to claim 11, wherein the generating of the low-dimensional precoding vectors comprises:
generating antenna-domain low-dimensional precoding vectors from among the low-dimensional precoding vectors by performing dimensionality reduction transformation on the precoding vectors for the reporting target subbands using antenna-domain principal component vectors; and
generating subband-domain low-dimensional precoding vectors from among the antenna-domain low-dimensional precoding vectors by performing dimensionality reduction transformation on the antenna-domain low-dimensional precoding vectors using subband-domain principal component vectors.

15. A method of a base station, comprising:
transmitting a reference signal to a terminal;
receiving a quantized low-dimensional precoding vector based on the reference signal from the terminal;
generating a low-dimensional precoding vector by dequantizing the quantized low-dimensional precoding vector; and
reconstructing a precoding vector from the low-dimensional precoding vector.

16. The method according to claim 15, wherein in the reconstructing of the original precoding vector, the precoding vector is reconstructed from the low-dimensional precoding vector in an inverse principal component analysis scheme.

17. The method according to claim 15, further comprising: restoring an original precoding vector from the reconstructed precoding vector by using an artificial neural network.

18. The method according to claim 17, wherein the artificial neural network is one of a fully-connected neural network, a multi-layer perceptron, a convolutional neural network, or a transformer.

19. The method according to claim 15, wherein the quantized low-dimensional precoding vector is received together with information on a number of reduced dimensions and information on a bit length for each dimension, and the low-dimensional precoding vector is generated through dequantization on the quantized low-dimensional precoding vector using the information on the number of reduced dimensions and the information on the bit length.
